(19) United States
(12) Patent Application Publication
(10) Pub. No.: US 2013/0169816 A1
(43) Pub. Date: Jul. 4, 2013

(54) MONITORING AND MANAGING DEVICE, MONITORING AND MANAGING SYSTEM AND METHOD OF DATA CENTER

(71) Applicants: Jhen-Jia Hu, Changhua County (TW); Hung-Ming Tai, Tainan City (TW); Hui-Chieh Li, Taoyuan County (TW)

(72) Inventors: Jhen-Jia Hu, Changhua County (TW); Hung-Ming Tai, Tainan City (TW); Hui-Chieh Li, Taoyuan County (TW)

(21) Appl. No.: 13/338,611

(22) Filed: Dec. 28, 2011

(51) Int. Cl. H04N 7/18

(52) U.S. Cl. 348/159; 348/E07.085

(57) ABSTRACT

A monitoring and managing method applied to a data center comprising racks is provided, wherein each rack comprises at least one electronic apparatus, and the monitoring and managing method comprises: capturing an image from a panel side of the racks to generate a first visible light image; capturing a non-visible light image of a heat dissipation side of the racks; using image recognition to determine the status of light signals and network ports of the at least one electronic apparatus and forming status information according to the first visible light image; storing the first visible light image and the non-visible light image; determining whether there is an abnormal event of the data center according to the first visible light image, the status information and profile of the data center.

### REPRESENTATIVE FIGURE

### Representative Figure

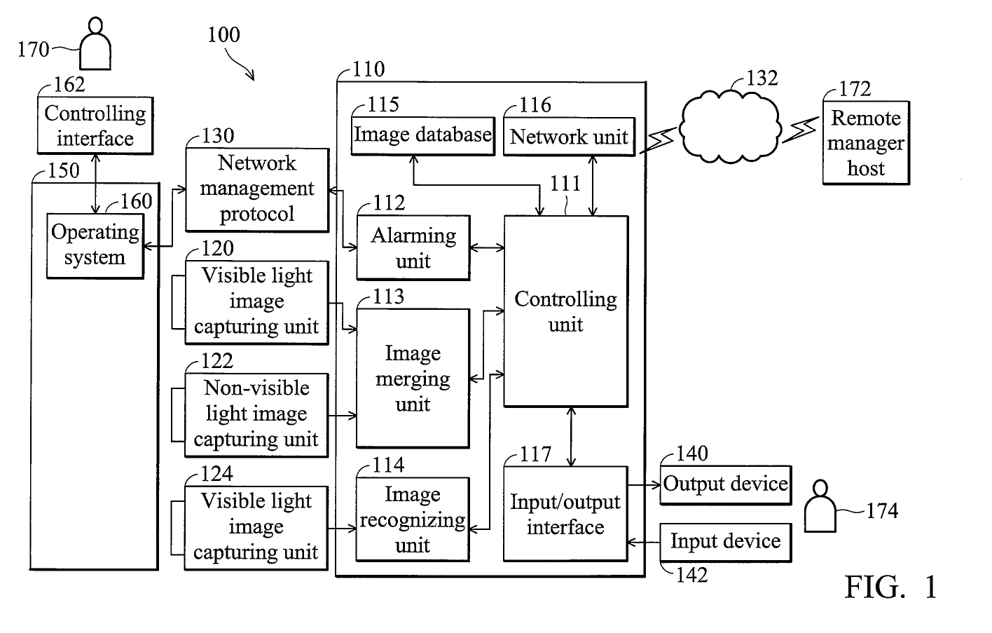

The representative figure of the disclosure is FIG. 1.

### Brief Description of Reference Numerals of the Representative Figure

100˜monitoring and managing system;

110˜monitoring and managing device;

111˜controlling unit;

112˜alarming unit;

113˜image merging unit;

114˜image recognizing unit;

115˜image database;

116˜network unit;

117˜input/output interface;

120˜visible light image capturing unit;

122˜non-visible light image capturing unit;

124˜visible light image capturing unit;

130˜network management protocol;

132˜Internet;

140˜output device;

142˜input device;

160˜operating system;

162˜controlling interface;

170˜data center user;

172˜remote manager host; and

174˜near-end manager.

### DESCRIPTION OF THE INVENTION

1. Field of the Invention

The disclosure relates to a data center and more particularly to monitoring and managing technology of the data center.

2. Description of the Related Art

With the development of cloud technology, the arrangement of machine rooms, power allocation, network transmission architecture, traffic management and so on in a data center have become much more complicated than in the past. The trend of current data centers is to use containers to arrange devices of a data center compactly. These kinds of data centers mainly face the following four problems:

1. Not Easy to Monitor Thermal Distribution.

Since devices in a container data center are arranged compactly, thermal density in the data center becomes higher and higher. Thus, it is harder and harder to monitor possible hot zones in the data center. In addition, for monitoring thermal distribution of the data center, a single thermal image and visual interpretation of people managing the data center are used to determine which device in the data center is overheated. However, visual interpretation of different people may have differences. Furthermore, compactly-arranged devices increase the difficulty of visual interpretation.

2. Not Easy to Recognize the Status of Panel Lights and Network Ports.

Since devices are all compactly arranged in containers, it is not convenient for people managing the data center to come in and go out the container frequently. Therefore, people cannot monitor lights of a controlling panel of each device right in the container to know whether lights of the controlling panel are turned on or whether there is a good connection with network ports.

3. Not Easy to Manage Loads.

The data center uses its special operating system to dynamically allocate and manage virtual machines and load machines. However, since there are more and more devices in the data center, how to dynamically perform load management of virtual machines and physical machines to optimize efficiency of the data center becomes a challenge.

4. How to Improve Monitoring Reliability.

Point sensors such as temperature sensors and so on are arranged in the interior of the data center in prior arts. However, since covering ranges of point sensors are limited, a large amount of point sensors have to be arranged to get information of a big range, and thus the costs are increased. In addition, since point sensors cannot be arranged continuously, the status of places where no point sensor is arranged have to be determined by neighboring point sensors, and thus monitoring reliability is decreased. Furthermore, arranging point sensors at points makes the monitoring and management not flexible. Monitoring software may have to be entirely reset when some devices are moved. Accordingly, monitoring reliability has to be improved.

### BRIEF SUMMARY

In view of the above, the disclosure provides an intelligent monitoring and managing system of a data center to solve the described problems and manage the data center more efficiently.

One embodiment of the disclosure provides a monitoring and managing device, applied to a data center comprising a plurality of racks, wherein at least one electronic device is arranged in each of the plurality of racks, the monitoring and managing device comprising: at least one first visible light image capturing unit, capturing images of panel sides of the plurality of racks and generating at least one first visible light image; at least one non-visible light image capturing unit, capturing images of heat dissipating sides of the plurality of racks and generating at least one non-visible light image; an image recognizing unit, using image recognition to determine light statuses and connecting statuses of network ports of electronic devices of the plurality of racks according to the at least one first visible light image and generating at least one status information; an image database; a controlling unit, receiving the at least one first visible light image, the at least one non-visible light image and the at least one status information and storing the at least one first visible light image and the at least one non-visible light image in the image database; an alarming unit, receiving the at least one non-visible light image, the at least one first visible light image and the at least one status information through the controlling unit, receiving a profile of the data center from an operating system of the data center through a network management protocol, and determining whether an abnormal event has occurred in the data center according to the at least one non-visible light image, the at least one status information and the profile; a network unit, coupled to the Internet, wherein at least one remote host coupled to the Internet accesses the at least one non-visible light image and the at least one status information via the Internet and through the network unit; and an input/output interface, coupled to the at least one output device, wherein the at least one output device accesses the at least one non-visible light image and the at least one status information through the input/output interface and outputs the at least one non-visible light image and the at least one status information.

Another embodiment of the disclosure provides a monitoring and managing system applied to a data center comprising a plurality of racks, wherein at least one electronic device is arranged in each of the plurality of racks, the monitoring and managing system comprising: at least one first visible light image capturing unit, capturing images of panel sides of the plurality of racks and generating at least one first visible light image; at least one non-visible light image capturing unit, capturing images of heat dissipating sides of the plurality of racks and generating at least one non-visible light image; an image recognizing unit, using image recognition to determine light statuses and connecting statuses of network ports of electronic devices of the plurality of racks according to the at least one first visible light image and generating at least one status information; an image database; a controlling unit, receiving the at least one first visible light image, the at least one non-visible light image and the at least one status information and storing the at least one first visible light image and the at least one non-visible light image in the image database; and an alarming unit, receiving the at least one non-visible light image, the at least one first visible light image and the at least one status information through the controlling unit, receiving a profile of the data center from an operating system of the data center through a network management protocol, and determining whether an abnormal event has occurred in the data center according to the at least one non-visible light image, the at least one status information and the profile.

Still another embodiment of the disclosure provides a monitoring and managing method applied to a data center comprising a plurality of racks, wherein at least one electronic device is arranged in each of the plurality of racks, the monitoring and managing method comprising: capturing images of heat dissipating sides of the plurality of racks to generate at least one non-visible light image; capturing images of panel sides of the plurality of racks to generate at least one first visible light image; using image recognition to determine light statuses and connecting statuses of network ports of electronic devices of the plurality of racks according to the at least one first visible light image and generating at least one status information; storing the at least one first visible light image and the at least one non-visible light image; and determining whether an abnormal event has occurred in the data center according to the at least one non-visible light image, the at least one status information and a profile of the operating system

### DESCRIPTION OF THE EMBODIMENTS

The following descriptions are embodiments of the disclosure. The descriptions are made for the purpose of illustrating the general principles of the disclosure and should not be taken in a limiting sense. The scope of the disclosure is best determined by reference to the appended claims.

FIG. 1 is a schematic diagram of a monitoring and managing system 100 according to one embodiment of the disclosure. The monitoring and managing system 100 is used for monitoring and managing a container data center 150. The container data center 150 comprises a plurality of racks 152. Each rack 152 comprises a plurality of electronic devices, such as server nodes, computing nodes, storage nodes or switches.

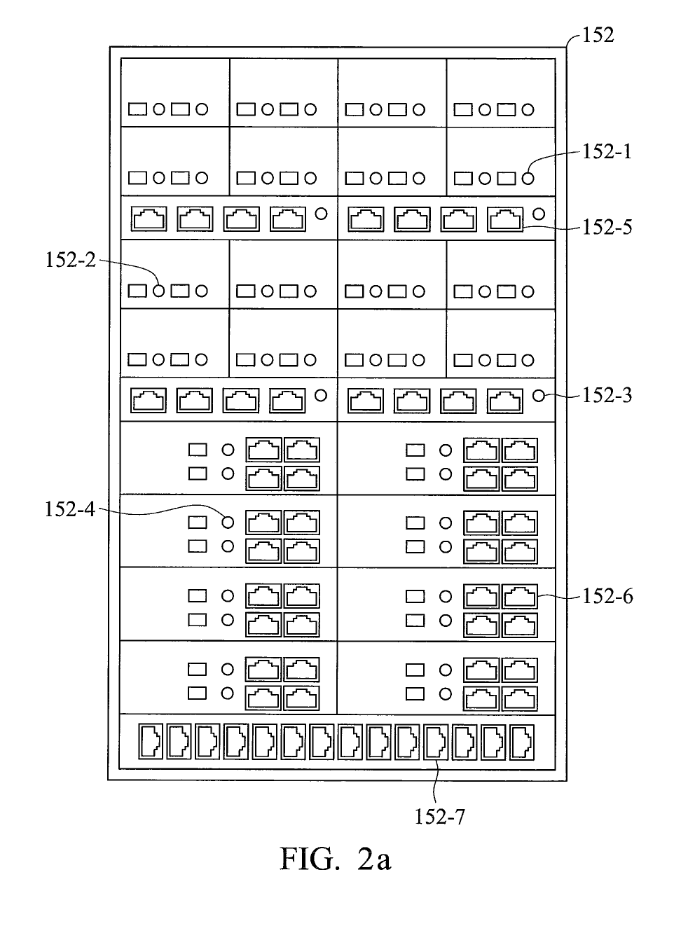

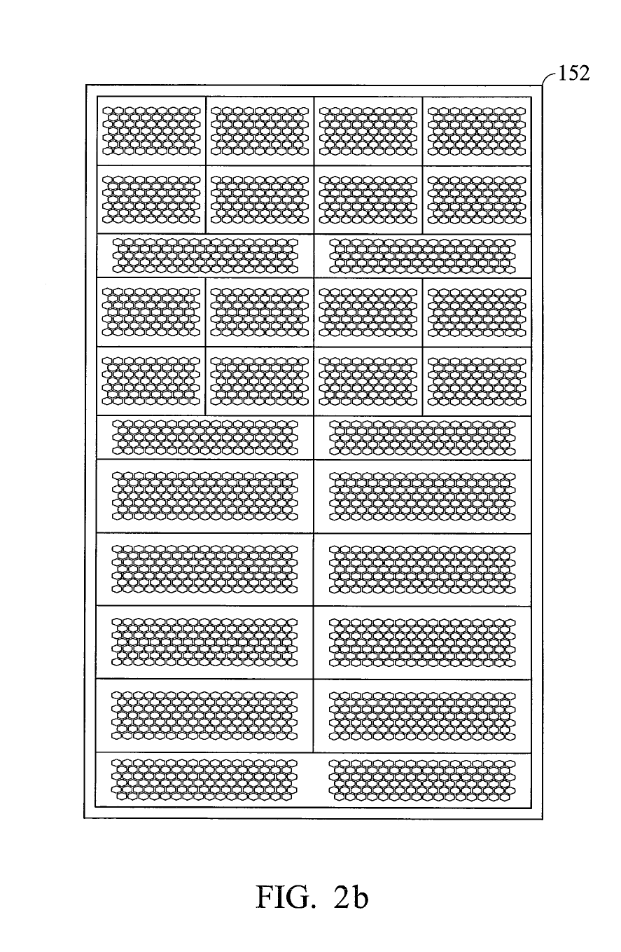

FIG. 2a is a schematic diagram of a panel side of the rack 152 according to one embodiment of the disclosure. Lights of each electronic device can be seen from the panel side of the rack 152, for example, lights 152-1, 152-2, 152-3 and 152-4. Network ports of each electronic device can also be seen from the panel side of the rack 152, for example, network ports 152-5, 152-6 and 152-7.

FIG. 2b is a schematic diagram of a heat dissipating side of the rack 152 according to one embodiment of the disclosure. Heat dissipation holes and heat dissipating fins of each electronic device in the rack 152 are arranged in the heat dissipating side.

In FIG. 1, an operating system 160 designated for data centers are installed in the data center 150. A data center user 170 can manipulate and manage the data center 150 through a controlling interface 162 (such as a graphical interface). For example, the user can control how many virtual machines are installed on which physical machine, i.e. on which electronic device. Settings on the controlling interface 162 set by the data center user 170 are stored as a profile of the operating system 160. The profile shows an operating condition of the data center 150, comprising a load allocation and so on, such as an allocation condition recording how virtual machines corresponds to physical machines.

The monitoring and managing system 100 comprises a monitoring and managing device 110, a visible light image capturing unit 120, a non-visible light image capturing unit 122 and a visible light image capturing unit 124. The monitoring and managing device 110 comprises a controlling unit 111, an alarming unit 112, an image merging unit 113, an image recognizing unit 114, an image database 115, a network unit 116 and an input/output interface 117. Signals and data are transmitted between the alarming unit 112 and the operating system 160 through a network management protocol 130.

The visible image capturing unit 124 aims at the panel side, as shown in FIG. 2a, of the rack 152. The visible image capturing unit 124 captures a panel image of the panel side of the rack 152 and transmits the panel image to the image recognizing unit 114. The image recognizing unit 114 utilizes image recognition technology to analyze the panel image so as to determine light statuses of each electronic device in the rack 152. For example, the recognizing unit 114 determines whether lights of electronic devices are green representing a normal operation or orange representing an abnormal operation. In addition, the image recognizing unit 114 also utilizes image recognition technology to analyze the panel image so as to determine connecting statuses of network ports of each electronic device in the rack 152. For example, the recognizing unit 114 determines whether network ports are connected to network cables or network cables are off. The image recognizing unit 114 generates status information of the data center 150 according to recognizing results of light statuses and connecting statuses and records light statuses and connecting statuses of each electronic device.

The visible light image capturing unit 120 and the non-visible light image capturing unit 122 aim at the heat dissipating side, as shown in FIG. 2b, of the rack 152. The visible light image capturing unit 120 captures a structure image of the heating dissipating side of the rack 152 to obtain a relative position of each electronic device in the rack. The non-visible light image capturing unit 122 captures a thermal image of the heat dissipating side of the rack 152 to obtain temperature information of each electronic device. The visible light image capturing unit 120 transmits the structure image of the heating dissipating side of the rack 152 to the image merging unit 113 and the non-visible light image capturing unit 122 transmits the thermal image of the heat dissipating side of the rack 152 to the image merging unit 113. The image merging unit 113 merges the structure image and the thermal image to generate a merged image. The temperature distribution of the rack 152 can be determined according to the merged image. In one example, the non-visible light image capturing unit 122 is a far-infrared light image capturing unit.

The number of the visible light image capturing unit 120, the non-visible light image capturing unit 122 and the visible image capturing unit 124 can be arranged to be more than one. The number depends on the size of the data center. For example, if there is more than one visible image capturing unit 124, images of all visible image capturing units 124 can be merged to be a big image according to corresponding positions or stored corresponding to relative positions of visible image capturing units 124 in the rack.

In one example, the visible light image capturing unit 120 and the non-visible light image capturing unit 122 can be integrated in a single component.

To be noted, schematic diagrams of the panel side and the heat dissipating side in FIG. 2a and FIG. 2b are only exemplified embodiments and should not be taken in a limiting sense. The person having ordinary skill in the art can change the arrangement of the panel side and the heat dissipating side according to the arrangement of the data center. For example, the panel side and the heat dissipating may be in the same side in some data centers, or network ports and lights may be at different sides. Thus, image capturing units can be reduced or increased in accordance to the arrangement of the data center.

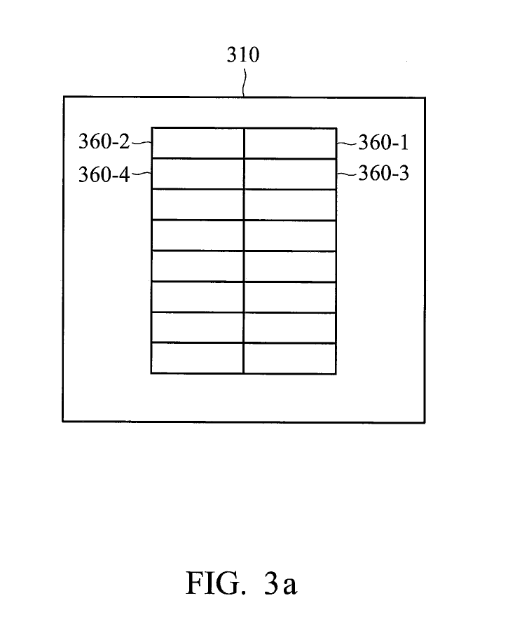

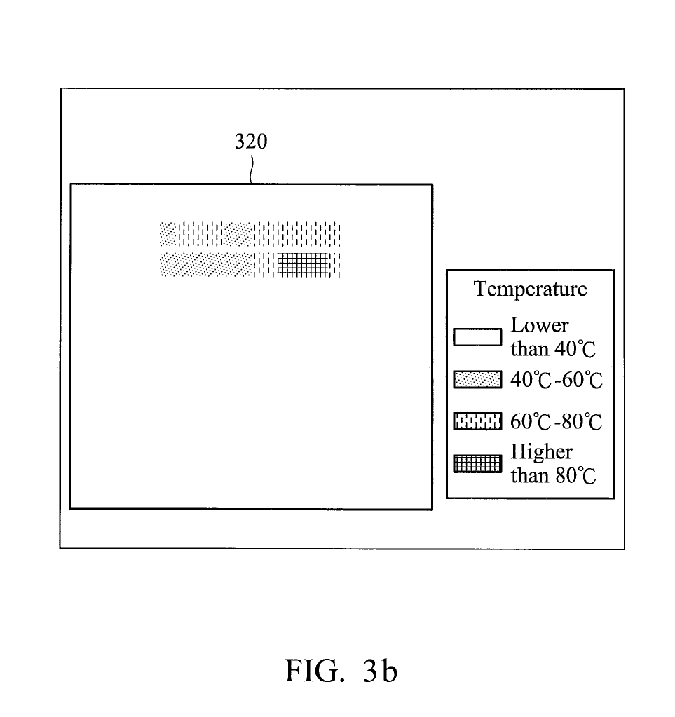

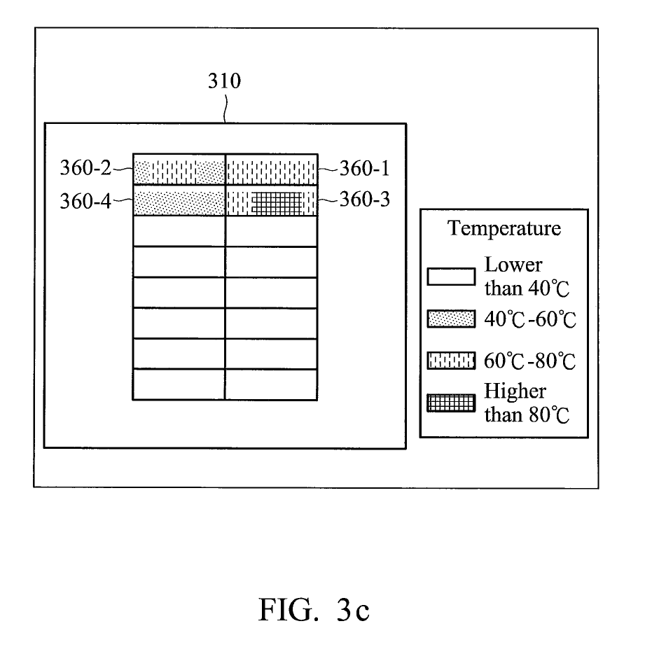

FIG. 3a to FIG. 3c are schematic diagrams of merged images according to one embodiment of the disclosure. A structure image 310 and a thermal image 320 are merged in a merged image 300. The structure image 310 shows an image containing at least electronic devices 360-1, 360-2, 360-3 and 360-4 of a rack 350. The arrangement of each electronic device in the rack, such as a position of a server node in the rack, can be determined according to the structure image captured by the visible light image capturing unit 120. Temperature information is corresponding to which electronic device in the rack cannot be determined only according to the thermal image 320, while the electronic device with the highest temperature in the rack can be determined according to the merged image 300. As shown in FIG. 3c, the electronic device 360-3 can be determined to be the one with the highest temperature. Therefore, the electronic device 360-3 may be over-loaded. In other embodiments, if the thermal image 320 is captured by a more high-level apparatus, temperature information of the rack can be determined only according to the thermal image 320.

The controlling unit 111 receives the status information from the image recognizing unit 114 and receives the merged image from the image merging unit 113. The controlling unit 111 stores the panel image, the structure image and the thermal image of the rack in the image database 115 corresponding to the number (position) of the rack and the captured time.

Further, the controlling unit 111 transmits the status information and the merged image to the alarming unit 112. The alarming unit 112 receives the profile of the operating system 160 of the data center through the network management protocol 130. The alarming unit 112 generates temperature information of the data center 150 according to the merged image. For example, the temperature information of the data center 150 records temperature corresponding to each electronic device. The alarming unit 112 determines whether one of the alarm criteria is met according to the temperature information, the status information and the profile. For example, the first alarm criterion is that temperature of an electronic device is higher than 80° C., the second alarm criterion is that a light of an electronic device arranged to have load is not turned on, and the third alarm criterion is that a network cable which should be connected is not connected. For example, if temperature of an electronic device is higher than 80° C. according to the temperature information, the first alarm criterion is met. If an electronic device which should be operating according to the profile is not operating (temperature of the electronic device is too low or/and the light of the electronic device is not turned on), the second alarm criterion is met. Thus, if any one of the alarm criteria is met, the data center 150 has an abnormal event.

The alarming unit 112 can compare the temperature information and the status information with the profile. For example, whether there is a difference between the arrangement of the profile and the temperature information and the status information is determined. If the difference is bigger than a predetermined value, it means an abnormal event has occurred in the data center. For example, if there should be 10 operating electronic devices in accordance with the profile, but in fact there are only 8 operating electronic devices according to the temperature information and the status information, then the data center 150 has an abnormal event. An abnormal event can be an abnormal light status, an abnormal temperature, setting errors of the operating system and so on.

The alarming unit 112 not only determines whether an abnormal event has occurred in the data center according to current temperature information and current status information but also accesses previous panel images, previous structure images and previous thermal images stored in the image database 115 to get corresponding previous temperature information and previous status information or temperature information and status information of other parts of the data center such as other racks. For example, the alarming unit can determine whether there is any abnormal event according to temperature information and status information of different parts of the rack at the same time. Also, the alarming unit can determine whether there is an abnormal event according to temperature information and status information in different time periods of the same parts of the rack. Further, the alarming unit can determine whether there is any abnormal event according to temperature information and status information in different time periods of different parts of the rack.

If the alarming unit 112 determines that an abnormal event has occurred in the data center, the alarming unit 112 transmit an alarm signal to the operating system 160 to make the operating system 160 perform load management. For example, the operating system 160 cooperates with modules equipped in the operating system 160, such as a physical resource management (PRM) module, a static resource provisioning management (PRM) module, a dynamic runtime virtual machine management (DVMM) module, a distributed main storage management (DMS) module, a distributed secondary storage management (DSS) module, a scalable load balancer (SLB) module and so on, to perform load management of the data center 150.

When the alarming unit 112 determines that temperature of one of electronic devices is higher than a predetermined temperature of the alarm criteria according to the temperature information and the alarm criteria, the alarming unit 112 transmits a load transferring command to the operating system 160 through the network management protocol 130 to make the operating system 160 transfer at least one of a plurality of virtual machines installed on the electronic device to another electronic device according to the load transferring command. For example, according to the profile of the operating system 160, virtual machines VM1, VM2, VM3 and VM4 are arranged on a server node SN1. After the visible light image capturing unit 120, the non-visible light image capturing unit 122 and the visible light image capturing unit 124 respectively capture the structure image, the thermal image and the panel image, as described above, the alarming unit 112 obtains the temperature information according to the merged image formed by merging the structure image and the thermal image and obtains the status information from the image recognizing unit 114. When the alarming unit 112 determines temperature of the server node SN1 is higher than 80° C. set by the alarm criteria, the alarming unit 112 transmits a load transferring command of the server node SN1 to the operating system 160 through the network management protocol 130. According to the load transferring command of the server node SN1, the operating system 160 transfers one virtual device of or parts (for example, 10%) of the virtual machines VM1, VM2, VM3 and VM4, arranged on the server node SN1, to another server node SN2 so as to accomplish the effect of load management. When transferring virtual machines, which virtual machine is going to be transferred can be decided according to the load of each virtual machine. For example, a virtual machine having the largest load has the highest priority to be transferred.

When the alarming unit 112 determines that an electronic device has failed according to the temperature information, the status information and the profile, the alarming unit 112 transmits a failure command to the operating system 160 through the network management protocol 130 to make the operating system 160 transfer all virtual machines installed on the electronic device to another electronic device according to the failure command. For example, according to the profile of the operating system 160, virtual machines VM5, VM6, VM7 and VM8 are arranged on a computing node CN1, and thus the computing node CN1 should be in an operating status. After the visible light image capturing unit 120, the non-visible light image capturing unit 122 and the visible light image capturing unit 124 respectively capture the structure image, the thermal image and the panel image, as described above, the alarming unit 112 obtains the temperature information according to the merged image formed by merging the structure image and the thermal image and obtains the status information from the image recognizing unit 114. When the alarming unit 112 determines that the temperature of the computing node CN1 is lower than 30° C., the whole computing node CN1 is determined to be operating normally. Otherwise, according to the temperature information, when the alarming unit 112 detects that the light of the computing node CN1 is not green, which represents normal operation, but orange, which represents abnormal operation, the alarming unit 112 determines that the whole computing node CN1 is not operating normally. When the alarming unit 112 determines that the whole computing node CN1 is not operating normally, the alarming unit 112 transmits a failure command of the computing node CN1 to the operating system 160 through the network management protocol 130 to make the operating system 160 transfer all virtual machines VM5, VM6, VM7 and VM8 of the computing node CN1 to another computing node CN2.

When the operating system 160 performs transfer of virtual machines as described above, the operating system 160 can access the status information and the temperature information through the network management protocol 130 and the alarming unit 112 at any time to make sure whether the abnormal event has been eliminated by the transferring action. If not, the operating system 160 proceeds to a next stage of transferring.

The corresponding relationship between virtual machines and physical machines is recorded by a table. The table records usage rates of a central processing unit (CPU) and a memory of each physical machine and also records every virtual machine, which is created by a virtual machine module, corresponding to each physical machine. For example, a usage rate of a CPU of a physical machine PM1 is 0%, a usage rate of a memory is 27%, and a virtual machine list of the physical machine PM1 records names of four virtual machines.

When the data center user knows that a usage rate of CPU or a usage rate of memory of a physical machine, such as a physical machine PM4, is too high (higher than a predetermined value) from the table, or when the data center user receives an alarm signal transmitted by the alarming unit and then examines the table to find that the usage rate of CPU or the usage rate of memory of the physical machine PM4 is too high, the data center user can transfer one virtual machine listed under the physical machine PM4 to any other physical machine that isn't overloaded. The data center user can also modify the arrangement of virtual machines according to the merged image or the thermal image. In addition, because of other special considerations, the data center user can feel free to arrange virtual machines according to the table, the merged image or the thermal image so as to manage loads easily. A load management program can use a graphical interface to show the table and to make the data center user drag names of virtual machines to virtual machine lists of other physical machines so as to arrange virtual machines easily.

Furthermore, when the alarming unit 112 determines that the data center 150 has an abnormal event, the alarming unit 112 transmits an alarm signal to the input/output interface 117 and the network unit 116 through the controlling unit 111. Then the input/output interface 117 transmits the alarm signal to an output device 140 and the network unit 116 transmits the alarm signal to a remote manager host 172 through Internet 132. For example, if the output device 140 is a display device having a speaker, the alarm signal makes the output device 140 generate alarm sound to remind a near-end manager 174 of abnormal events, and thus the near-end manager 174 can be aware of abnormal events immediately and proceed to eliminate abnormal events.

The remote manager host 172 can also access the merged image and the status information at any time via the Internet 132 and the network unit 116 and through the controlling unit 111. Similarly, the near-end manager 174 can use the output device 140 to access the merged image and the status information via the input/output interface 117 and through the controlling unit 111, and thus the near-end manager 174 can monitor statuses of the data center.

In addition, the data center user 170 can access the merged image and the status information through the operating system 160, the network management protocol 130, the alarming unit 112 and the controlling unit 111 to monitor the status of the data center. The data center user 170, the remote manager host 172 and the near-end manager 174 can access previous images stored in the image database. In addition, different access authorities can be assigned to the data center user 170, the remote manager host 172 and the near-end manager 174 to make the data center user 170, the remote manager host 172 and the near-end manager 174 manage the data center with varying degrees according to their authorities.

In another example, the controlling unit 111 can make some rudimentary decision in advance and then determine whether the temperature information and the status information are going to be transmitted to the alarming unit 112. For example, the controlling unit 111 obtains the profile of the operating system 160 through the alarming unit 112 and the network management protocol 130 and compares the temperatures information, the status information and the profile. If the temperature information or/and the status information is/are the same as the profile or has/have differences smaller than a predetermined value compared with the profile, which means the data center is operating normally, the controlling unit 111 stores the panel image, the structure image and the thermal image in the image database 115 corresponding to the number (position) of the rack and the captured time. If the temperature information or/and the status information has/have differences higher than the predetermined value compared with the profile, which means the data center is operating abnormally, the controlling unit 111 transmits the merged image and the status information to the alarming unit 112 to make the alarming unit 112 make a further decision and transmit signals to the operating system 116 to make the operating system 116 perform load balance and other actions. The described predetermined value can be a threshold value of an alarm criterion. For example, the safety temperature is 70° C. and the tolerance is ±2° C.

In addition, the data center user 170 manipulates and manages the data center 150 through a controlling interface 162 and sets the alarm criteria at the same time. In addition, the remote manager host 172 can set the alarm criteria through the Internet 132 and the network unit 116 and the near-end manager 174 can set the alarm criteria through an input device 142 and the input/output interface 117. The alarm criteria can be stored in the profile, the controlling unit 111 and the alarming unit 112.

Though the description above mainly focuses on a rack of the data center, according to the arrangement of the data center and resolutions of image capturing units, images of a number of racks can be captured at a time, or an image of only a portion of a rack is captured at a time. In addition, though only thermal images of heat dissipating sides of racks are captured in the described embodiments, thermal images of panel sides of racks can be captured according to different managing requirements.

The controlling unit 111, the alarming unit 112, the image merging unit 113, the image recognizing unit 114, the network unit 116 and the input/output interface 117 are processing units having functions of general processors.

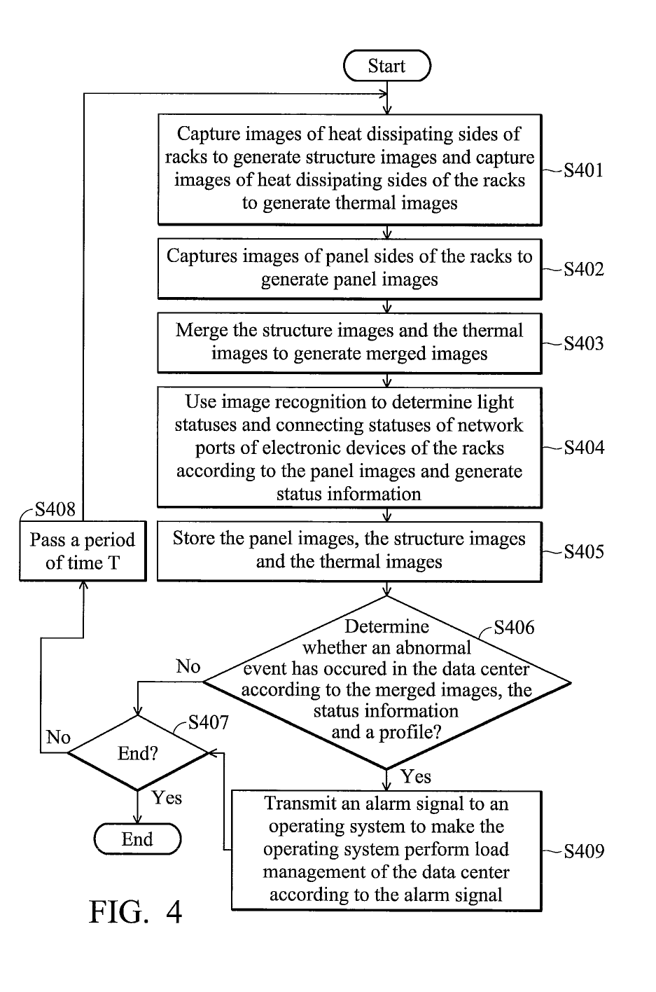

FIG. 4 is a flowchart of a monitoring and managing method 400 according to one embodiment of the disclosure. The monitoring and managing method 400 is applied to a container data center 260. The data center 150 comprises a plurality of racks 152. Each rack 152 comprises a plurality of electronic devices. In the following description, steps, symbols and numerals of elements that are the same as elements in FIG. 1 use the same symbols and numerals as in FIG. 1

In step S401, the visible light image capturing unit 120 captures images of heat dissipating sides of the plurality of racks to generate structure images and the non-visible light image capturing unit 122 captures images of heat dissipating sides of the plurality of racks to generate thermal images. In step S402, the visible light image capturing unit 124 captures images of panel sides of the plurality of racks to generate panel images. Then in step S403, the image merging unit 113 merges the structure images and the thermal images to generate corresponding merged images. In step S404, the image recognizing unit 114 uses image recognition to determine light statuses and connecting statuses of network ports of electronic devices of the plurality of racks according to the panel images and generate status information.

In step S405, the controlling unit 111 stores the panel images, the structure images and the thermal images in the image database 115 corresponding to numbers (positions) of racks and captured time. In step S406, the alarming unit 112 determines whether an abnormal event has occurred in the data center according to the merged images, the status information and a profile of the data center. The alarming unit 112 generates temperature information of the data center 150 according to the merged images. The alarming unit 112 determines whether one of the alarm criteria is met according to the temperature information, the status information and the profile. If yes, the alarming unit 112 determines that the data center 150 has an abnormal event.

If there is no abnormal event, whether the monitoring and managing method ends in step S407 is determined. If not, step S401 is performed after a period of time (for example, 1 to 10 minutes) goes by in step S408. If yes, the monitoring and managing method ends.

If the alarming unit 112 determines that there is an abnormal event in step S406, the alarming unit 112 transmits an alarm signal to the operating system 160 in step S409 and makes the operating system 160 perform load management of the data center 150 according to the alarm signal. If the temperature of one of the electronic devices is higher than a predetermined temperature of the alarm criteria, the alarming unit 112 transmits a load transferring command to the operating system to make the operating system 160 transfer one or parts of the virtual machines installed on the electronic device to another electronic device according to the load transferring command. Except for the load management action as described above, the disclosure can perform actions of back up, failure recovery and even turning the electronic device off directly.

The monitoring and managing method as described above can also be used to monitor electronic systems other than data centers, such as mainframes or super computers.

As described above, the merged images formed by merging the thermal images and the structure images are used to obtain corresponding temperatures of each electronic device rapidly, without requiring the arrangement of a large amount of point sensors. Thus, computation of determining corresponding temperatures in the disclosure is not influenced even when the arrangement of electronic devices in the data center is changed. In addition, unlike point sensors, by which the captured information is not continuous in space, image capturing units capture continuous information of a whole plane, and thus reliability increases. Furthermore, lights of the panel and statuses of network ports can be recognized from panel images by image recognition. Temperature information and status information obtained from the merged images and the panel images can make the alarming unit determine load conditions and operating conditions of the data center more efficiently and reliably. When the alarm unit detects an abnormal events, the alarm unit sends feedback to the operating system of the data center to make the operating system perform load management and other actions according to the reliable alarm signal. Therefore, according to the invention, the data center can be monitored and managed more efficiently and more reliably

Methods and systems of the present disclosure, or certain aspects or portions of embodiments thereof, may take the form of a program code. The program code is embodied in physical media, such as floppy diskettes, CD-ROMS, hard drives, or any other electronic devices or machine-readable (for example, computer readable) storage medium, wherein, when the program code is loaded into and executed by a machine, such as a computer, the machine becomes an apparatus or a system for practicing embodiments of the disclosure and may carry out steps of the methods. The program code may be transmitted over some transmission medium, such as electrical wiring or cabling, through fiber optics, or via any other form of transmission, wherein, when the program code is received and loaded into and executed by a machine, such as a computer, the machine becomes a system or an apparatus for practicing embodiments of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

### BRIEF DESCRIPTION OF THE FIGURES

FIG. 1 is a schematic diagram of a monitoring and managing system according to one embodiment of the disclosure;

FIG. 2a is a schematic diagram of a panel side of a rack according to one embodiment of the disclosure;

FIG. 2b is a schematic diagram of a heat dissipating side of a rack according to one embodiment of the disclosure;

FIG. 3a to FIG. 3c are schematic diagrams of merged images according to one embodiment of the disclosure; and

FIG. 4 is a flowchart of a monitoring and managing method according to one embodiment of the disclosure.

### BRIEF DESCRIPTION OF THE REFERENCE NUMERALS OF MAJOR COMPONENTS

100˜monitoring and managing system;

110˜monitoring and managing device;

111˜controlling unit;

112˜alarming unit;

113˜image merging unit;

114˜image recognizing unit;

115˜image database;

116˜network unit;

117˜input/output interface;

120˜visible light image capturing unit;

122˜non-visible light image capturing unit;

124˜visible light image capturing unit;

130˜network management protocol;

132˜Internet;

140˜output device;

142˜input device;

150˜data center;

152, 130˜rack;

152-1, 152-2, 152-3, 152-4˜light;

152-5, 152-6, 152-7˜network port;

160˜operating system;

162˜controlling interface;

170˜data center user;

172˜remote manager host;

174˜near-end manager;

300˜merged image;

310˜structure image;

320˜thermal image;

360-1, 360-2, 360-3, 360-4˜electronic device;

S401, S402 . . . S408˜step.

What is claimed is:

1. A monitoring and managing device, applied to a data center comprising a plurality of racks, wherein at least one electronic device is arranged in each of the plurality of racks, comprising:
at least one first visible light image capturing unit, capturing images of panel sides of the plurality of racks and generating at least one first visible light image;
at least one non-visible light image capturing unit, capturing images of heat dissipating sides of the plurality of racks and generating at least one non-visible light image;
an image recognizing unit, using image recognition to determine light statuses and connecting statuses of network ports of electronic devices of the plurality of racks according to the at least one first visible light image and generating at least one status information;
an image database;
a controlling unit, receiving the at least one first visible light image, the at least one non-visible light image and the at least one status information and storing the at least one first visible light image and the at least one non-visible light image in the image database;
an alarming unit, receiving the at least one non-visible light image, the at least one first visible light image and the at least one status information through the controlling unit, receiving a profile of the data center from an operating system of the data center through a network management protocol, and determining whether an abnormal event has occurred in the data center according to the at least one non-visible light image, the at least one status information and the profile;
a network unit, coupled to the Internet, wherein at least one remote host image and the at least one status information via the Internet and through the network unit; and
an input/output interface, coupled to at least one output device, wherein the at least one output device accesses the at least one non-visible light image and the at least one status information through the input/output interface and outputs the at least one non-visible light image and the at least one status information.

2. The monitoring and managing device as claimed in claim 1, wherein if the alarming unit determines that an abnormal event has occurred in the data center, the alarming unit transmits an alarm signal to the operating system through the network management protocol and makes the operating system perform load management according to the alarm signal.

3. The monitoring and managing device as claimed in claim 2, wherein the profile at least comprises corresponding relationships of the electronic devices of the data center and a plurality of virtual machines.

4. The monitoring and managing device as claimed in claim 3, further comprising:
at least one second visible light image capturing unit, capturing images of the heat dissipating sides of the plurality of racks and generating at least one second visible light image; and
at least one image merging unit, merging the at least one second visible light image and the at least one non-visible light image to generate at least one merged image.

5. The monitoring and managing device as claimed in claim 4, wherein the alarming unit generates at least one temperature information of the data center according to the at least one non-visible light image or the at least one merged image, determines whether one of alarm criteria is met according to the at least one temperature information, the at least one status information and the profile, and if yes, the alarming unit determines that an abnormal event has occurred in the data center.

6. The monitoring and managing device as claimed in claim 5, wherein the at least one remote host sets the alarm criteria via the Internet through the network unit, wherein the input/output interface is further coupled to at least one input device, and the at least one input device sets the alarm criteria through the input/output interface, and the controlling unit transmits the alarm criteria to the alarming unit.

7. The monitoring and managing device as claimed in claim 5, wherein the operating system receives commands through a controlling interface of the operating system to set the alarm criteria, and the alarm criteria is transmitted to the alarming unit through the network management protocol.

8. The monitoring and managing device as claimed in claim 5, wherein the alarming unit determines the temperature of each of the electronic devices according to the at least one non-visible light image or the at least one merged image so as to generate the at least one temperature information.

9. The monitoring and managing device as claimed in claim 5, wherein according to the at least one temperature information, if temperature of one electronic device of the electronic devices exceeds a predetermined temperature of the alarm criteria, the alarming unit transmits a load transferring command to the operating system through the network management protocol to make the operating system transfer at least one of a plurality of virtual machines installed on the electronic device to another electronic device according to the load transferring command.

10. The monitoring and managing device as claimed in claim 5, wherein the alarming unit determines whether one electronic device of the electronic devices has failed according to the at least one temperature information, the at least one status information and the profile, and if yes, the alarming unit transmits a failure command to the operating system to make the operating system transfer all virtual machines installed on the electronic device to another electronic device according to the failure command.

11. A monitoring and managing system for data centers, applied to a data center comprising a plurality of racks, wherein at least one electronic device is arranged in each of the plurality of racks, comprising:
at least one first visible light image capturing unit, capturing images of panel sides of the plurality of racks and generating at least one first visible light image;
at least one non-visible light image capturing unit, capturing images of heat dissipating sides of the plurality of racks and generating at least one non-visible light image;
an image recognizing unit, using image recognition to determine light statuses and connecting statuses of network ports of electronic devices of the plurality of racks according to the at least one first visible light image and generating at least one status information;
an image database;
a controlling unit, receiving the at least one first visible light image, the at least one non-visible light image and the at least one status information and storing the at least one first visible light image and the at least one non-visible light image in the image database; and
an alarming unit, receiving the at least one non-visible light image, the at least one first visible light image and the at least one status information through the controlling unit, receiving a profile of the data center from an operating system of the data center through a network management protocol, and determining whether an abnormal event has occurred in the data center according to the at least one non-visible light image, the at least one status information and the profile.

12. The monitoring and managing system as claimed in claim 11, wherein if the alarming unit determines that an abnormal event has occurred in the data center, the alarming unit transmits an alarm signal to the operating system through the network management protocol and makes the operating system perform load management according to the alarm signal.

13. The monitoring and managing system as claimed in claim 12, wherein the alarming unit determines whether one electronic device of the electronic devices has failed according to the at least one temperature information, the at least one status information and the profile, and if yes, the alarming unit transmits a failure command to the operating system to make the operating system transfer all virtual machines installed on the electronic device to another electronic device according to the failure command.

14. The monitoring and managing system as claimed in claim 13, further comprising:
at least one second visible light image capturing unit, capturing images of the heat dissipating sides of the plurality of racks and generating at least one second visible light image; and
at least one image merging unit, merging the at least one second visible light image and the at least one non-visible light image to generate at least one merged image.

15. The monitoring and managing system as claimed in claim 14, wherein the alarming unit generates at least one temperature information of the data center according to the at least one non-visible light image or the at least one merged image, determines whether one of alarm criteria is met according to the at least one temperature information, the at least one status information and the profile, and if yes, the alarming unit determines that an abnormal event has occurred in the data center.

16. The monitoring and managing system as claimed in claim 15, further comprising:
a network unit, coupled to the Internet, wherein at least one remote host coupled to the Internet accesses the at least one non-visible light image or the at least one merged image via the Internet through the network unit and accesses the at least one status information; and
an input/output interface, coupled to at least one output device, wherein the at least one output device accesses the at least one non-visible light image or the at least one merged image through the input/output interface, outputs the at least one non-visible light image or the at least one merged image, and accesses and outputs the at least one status information.

17. The monitoring and managing system as claimed in claim 15, wherein the at least one remote host sets the alarm criteria via the Internet through the network unit, wherein the input/output interface is further coupled to at least one input device, the at least one input device sets the alarm criteria through the input/output interface, and the controlling unit transmits the alarm criteria to the alarming unit.

18. The monitoring and managing system as claimed in claim 15, wherein the operating system receives commands through a controlling interface of the operating system to set the alarm criteria, and the alarm criteria is transmitted to the alarming unit through the network management protocol.

19. The monitoring and managing system as claimed in claim 15, wherein the alarming unit determines the temperature of each of the electronic devices according to the at least one non-visible light image or the at least one merged image so as to generate the at least one temperature information.

20. The monitoring and managing system as claimed in claim 15, wherein according to the at least one temperature information, if temperature of one electronic device of the electronic devices exceeds a predetermined temperature of the alarm criteria, the alarming unit transmits a load transferring command to the operating system through the network management protocol to make the operating system transfer at least one of a plurality of virtual machines installed on the electronic device to another electronic device according to the load transferring command.

21. The monitoring and managing system as claimed in claim 15, wherein the alarming unit determines whether one electronic device of the electronic devices has failed according to the at least one temperature information, the at least one status information and the profile, and if yes, the alarming unit transmits a failure command to the operating system to make the operating system transfer all virtual machines installed on the electronic device to another electronic device according to the failure command.

22. A monitoring and managing method for data centers, applied to a data center comprising a plurality of racks, wherein at least one electronic device is arranged in each of the plurality of racks, comprising:
capturing images of heat dissipating sides of the plurality of racks to generate at least one non-visible light image;
capturing images of panel sides of the plurality of racks to generate at least one first visible light image;
using image recognition to determine light statuses and connecting statuses of network ports of electronic devices of the plurality of racks according to the at least one first visible light image and generating at least one status information;
storing the at least one first visible light image and the at least one non-visible light image; and
determining whether an abnormal event has occurred in the data center according to the at least one non-visible light image, the at least one status information and a profile of the operating system.

23. The monitoring and managing method as acclaimed in claim 22, wherein if an abnormal event has occurred in the data center, an alarm message is transmitted to the operating system to make the operating system perform load management according to the operating system.

24. The monitoring and managing method as acclaimed in claim 23, wherein the profile at least comprises corresponding relationships of the electronic devices of the data center and a plurality of virtual machines.

25. The monitoring and managing method as acclaimed in claim 24, further comprising:
capturing images of the heat dissipating sides of the plurality of racks and generating at least one second visible light image; and
merging the at least one second visible light image and the at least one non-visible light image to generate at least one merged image.

26. The monitoring and managing method as acclaimed in claim 25, further comprising:
generating at least one temperature information of the data center according to the at least one non-visible light image or the at least one merged image; and
determining whether one of alarm criteria is met according to the at least one temperature information, the at least one status information and the profile, and if yes, determining an abnormal event has occurred in the data center.

27. The monitoring and managing method as acclaimed in claim 26, further comprising:
determining the temperature of each of the electronic devices according to the at least one non-visible light image or the at least one merged image to generate the at least one temperature information

28. The monitoring and managing method acclaimed in claim 26, further comprising:
according to the at least one temperature information, if temperature of one electronic device of the electronic devices exceeds a predetermined temperature of the alarm criteria, transmitting a load transferring command to the operating system to make the operating system transfer at least one of a plurality of virtual machines installed on the electronic device to another electronic device according to the load transferring command.

29. The monitoring and managing method as acclaimed in claim 26, further comprising:
determining whether one electronic device of the electronic devices has failed according to the at least one temperature information, the at least one status information and the profile; and
if yes, transmitting a failure command to the operating system to make the operating system transfer all virtual machines installed on the electronic device to another electronic device according to the failure command.
